(19) United States
(12) Patent Application Publication
(10) Pub. No.: US 2007/0197195 A1
(43) Pub. Date: Aug. 23, 2007

(54) Information notification controller, information notification system, and program

(76) Inventors: Keiji Sugiyama, Kyoto (JP); Junichi Hirai, Osaka (JP); Kakuya Yamamoto, Hyogo (JP)

Correspondence Address: WENDEROTH, LIND & PONACK L.L.P., 2033 K. STREET, NW, SUITE 800, WASHINGTON, DC, 20006, US

(21) Appl. No.: 10/592,389

(22) PCT Filed: Dec. 26, 2005
(86) PCT No.: PCT/JP05/23778

§ 371 Date: Sep. 12, 2006

(30) Foreign Application Priority Data
Jan. 31, 2005 (JP) 2005-005990

(51) Int. Cl. H04Q 7/22

(52) U.S. Cl. 455/412.2

(57) ABSTRACT

It is an object of the present invention to provide an information notification controller and an information notification control method that can provide information suited to users. It provides an information notification controller comprising a notification information reception unit 101 receiving first notification information; a notification information analysis unit 102 analyzing the type and/or content of the first notification information; a notification information management unit 103 managing temporal variations in the results of the analysis along with saving the first notification information in association with the results of the analysis; a user situation judgement unit 105 judging a user situation based on temporal variations in the results of analysis of the first notification information in the notification information management unit 103; and a notification information selection unit 107 selecting second notification information, which is outputted to a user terminal, from the first notification information in accordance with the user situation. As a result, the user current situation is judged based on the type, content, and the frequency, etc. of the information being currently received by the user, which allows for appropriate notification control to be exercised depending on the judgement of the situation.

### TECHNICAL FIELD

The present invention relates to an apparatus for controlling the method of information notification to user.

### TECHNICAL BACKGROUND

In the past, devices for controlling the method of information notification to users included devices that determined the type and content of information to be communicated to users based on information on the users' current location and information on the people surrounding the users or shops in the vicinity of the users (for example, see Published Japanese Patent Application No. H10-217326A). As a result, users could receive information corresponding to their present whereabouts, such as, for instance, advertising information on shops in the vicinity, etc.

Moreover, methods have been proposed, in which the content of e-mail messages transmitted to users are analyzed and, based on the type and occurrence frequency of words contained in the e-mail messages, judgement is made as to whether the users need the e-mail messages or not (for example, see Published Japanese Patent Application No. 2001-256795A). As a result, user discomfort due to receipt of spam or other unwanted e-mail messages can be prevented.

### DISCLOSURE OF THE INVENTION

However, reliance on only user-centric information, such as information on the user's surroundings and location, etc., is not sufficient to determine information to be communicated to the user. For instance, communicating entertainment information concerning the surroundings of a user who is being notified of information regarding family security by a home security system would not be appropriate and may offend the user.

Moreover, methods involving analysis of e-mail content based exclusively on statistical information, such as the frequency of word occurrence, etc., in order to determine whether notification can be sent are not sufficient in judging information communicated to the user. For instance, even though users normally filter out information containing a large number of words related to their regions or communities as unwanted e-mail, during a disaster, etc., in order to get an idea of damage in their surroundings, users may give priority to, and may need to collect, information including a large amount of region-related information.

It is an object of the present invention to provide an information notification controller and an information notification control method that resolve such conventional problems and can provide information suited to users.

To solve the problem, the first invention of this Application provides an information notification controller that selects second notification information from first notification information and outputs it. The information notification controller comprises a notification information reception unit receiving first notification information; a notification information analysis unit analyzing the type and/or content of the first notification information received by the notification information reception unit; a notification information management unit managing temporal variations in the results of the analysis performed by the notification information analysis unit along with saving the first notification information received by the notification information reception unit in association with the results of the analysis; a user situation judgement unit judging a user situation in accordance with temporal variations in the results of analysis of the first notification information saved by the notification information management unit; a notification information selection unit selecting second notification information from the first notification information in the notification information management unit in accordance with the user situation; and an output unit outputting the second notification information.

The information notification controller selects second notification information from first notification information for notifying the user terminals in accordance with temporal variations in the user situation. In addition, outputting the selected second notification information to the display etc. of a user terminal or its own terminal makes it possible to provide the user with constantly changing information in accordance with the user situation. Therefore, for instance, even in case of information with which the user has not been concerned, changes in the user situation with which the user becomes concerned can be detected by analyzing and managing temporal variations in the first notification information provided to the user based on, e.g. the type, content, and frequency of such information. In addition, information suited to users can be provided to the users by selecting information corresponding to the changed situation of the users and providing it to the users. As a result, it is possible to prevent notification of entertainment information to users waiting for regional disaster information and thus avoid hurting the user's feelings.

It should be noted that when the information notification controller is a server terminal, the server terminal outputs second notification information to the user terminals. The user terminal receiving the second notification information presents the second notification information to the user by displaying it on the display etc. of its own. On the other hand, when the information notification controller is a user terminal, the user terminal displays the second notification information selected by itself on a display, etc.

The second invention of this Application provides an information notification controller according to the first invention, which further comprises an informational priority level management unit managing the level of informational priority of the first notification information in association with the user situation and in which the notification information selection unit selects second notification information from the first notification information in the notification information management unit according to the level of informational priority corresponding to the user situation judged by the user situation judgement unit.

The information notification controller selects second notification information from first notification information based on the level of informational priority of the first notification information determined in accordance with temporal variations in the user situation. Since the level of informational priority corresponding to the user situation is managed in this manner, information of high-level informational priority can be selected as second notification information from the first notification information in accordance with the constantly changing situation of the user. Therefore, information wanted by the users can be outputted to the display etc. of a user terminal or its own terminal.

For example, let us assume that the categories of the first notification information include “Security Information”, “Family Information”, “Work Information”, and “Entertainment Information”, and that the situation of the user is “Security Oriented” or “Work Oriented”. Here, when the user situation is “Security Oriented”, a situation-dependent information management unit manages associations, in accordance with which the level of informational priority of “Work Information” and “Entertainment Information” is set to “Low” and the level of informational priority of “Security Information” and “Family Information” is set to “High”. In this case, when the user situation is judged as “Security Oriented”, information of high-level informational priority belonging to the categories of “Security Information” and “Family Information” is selected from the first notification information and outputted to the display etc. of a user terminal or its own terminal as second notification information.

The third invention of this Application provides an information notification controller according to the first invention, which further comprises an output method management unit managing the output method of the second notification information in accordance with the user situation, and in which the output unit outputs the second notification information in accordance with an output method corresponding to the user situation judged by the user situation judgement unit.

Outputting the second notification information to the display etc. of a user terminal or its own terminal by the output method according to the user situation allows for providing users with the second notification information in an appropriate manner. For instance, it is assumed that when the user situation is “Security Oriented”, output method management consists in providing instantaneous information concerned with “Security Information” to the display etc. of its own terminal or a user terminal currently used by the user. Here, when the user situation is judged as “Security Oriented”, information concerned with “Security Information” is selected and instantly outputted to the display etc. of the currently used user terminal or its own terminal, thereby providing appropriate information according to the user situation.

The fourth invention of this Application provides an information notification controller according to the first invention, in which the notification information analysis unit maintains a source list used to classify information into categories based on the sources of the information and analyzes the type and/or content of the received first notification information by applying the source list to source-related information contained in the first notification information received by the notification information reception unit.

This configuration makes it possible to infer the type and/or content of notification information without performing complicated semantic interpretation of notification information.

The fifth invention of this Application provides an information notification controller according to the first invention, wherein the notification information analysis unit maintains a weighted word list showing associations between specific words and information categories and analyzes the type and/or content of the first notification information by applying the weighted word list to words contained in the first notification information received by the notification information reception unit.

This configuration makes it possible to appropriately infer the type and/or content of notification information from the frequency of word occurrence when receiving instant messages and e-mail messages in HTML format or text format.

The sixth invention of this Application provides an information notification controller according to the first invention, wherein the notification information analysis unit maintains an ontology describing semantic relationships within information and analyzes the type and/or content of the first notification information by performing ontology-based semantic interpretation of metadata contained in the first notification information received by the notification information reception unit.

This configuration makes it possible to make a more detailed judgement of the type and/or content of notification information when metadata in RDF (Resource Description Framework) format etc. is attached to the notification information.

The seventh invention of this Application provides an information notification controller according to the first invention, wherein the notification information analysis unit analyzes the type and/or content of information by performing image recognition on image information contained in the first notification information received by the notification information reception unit.

This configuration makes it possible to infer the type and/or content of notification information when receiving image information containing no text information as notification information.

The eighth invention of this Application provides an information notification controller according to the first invention, which comprises a sensing information acquisition unit acquiring user information, and in which the user situation judgement unit judges a user situation in accordance with temporal variations in user information acquired from the sensing information acquisition unit in addition to temporal variations in the results of analysis of the first notification information saved by the notification information management unit.

The user situation judgement unit judges a user situation using user information such as information on the user's current location and surroundings acquired from the sensing information acquisition unit in addition to the content, type and reception frequency of the notification information saved by the notification information management unit. Therefore, the situation of the user can be determined in further detail with account taken of the information on the user's current location and surroundings. As a result, control over information notification is made possible such that, for instance, the priority level of information notification from a home security system is increased for users who are not at home, and the priority level of information notification from a home security system is lowered for users who are at home.

The ninth invention of this Application provides an information notification controller according to the first invention, wherein at least one of the type, content, and reception frequency of the first notification information is contained in the first notification information saved by the notification information management unit and user situation judgement unit judges the user situation based on at least one of the type, content, and reception frequency of the first notification information.

Based on this configuration, notification control of information that matches information received by the user is implemented such that, for instance, in a situation where there is a lot of notification information from family members, priority is given to delivery of information concerning the family, and in a situation where there is a lot of notification information from customers, delivery of information concerning the family is restricted, etc.

The tenth invention of this Application is characterized by the fact that, in the second invention, the output unit aggregates and outputs untransmitted information. Aggregating untransmitted information contained in the first notification information allows for transmission at a reduced information volume of the untransmitted information.

The eleventh invention of this Application provides an information notification controller according to the tenth invention, wherein the output unit aggregates information of low-level informational priority.

Because this configuration makes it possible to reduce the frequency, with which information that is currently of low-level priority to the user is communicated to the user and make the content of the communicated information more concise, it allows for a reduction in the time it takes the user to receive and review the contents of information of low-level priority. As a result, the time the user spends on unnecessary information can be reduced.

The twelfth invention of this Application provides an information notification controller according to the second invention, which further comprises an output timing management unit managing the output timing of the second notification information in association with the level of informational priority, and in which the output unit outputs the second notification information in accordance with an output timing corresponding to the level of informational priority of the second notification information.

In this manner, because the output unit modifies the timing of communicating information depending upon the priority level, the frequency of notification of information of low-level priority can therefore be reduced and the user can be prevented from being bothered by notification of unnecessary information. For instance, information of low-level priority is not communicated when the user is enjoying a movie etc., and, in the user's spare time, information notification is performed immediately regardless of the priority level, etc., such that information notification is carried out according to the user's situation within appropriate time intervals, which makes it possible to avoid situations, in which frequent information notification may hurt the user's feelings when the user is absorbed in other activities.

The thirteenth invention of this Application provides an information notification controller according to the second invention, which further comprises an output terminal management unit managing user terminals outputting the second notification information in association with the level of informational priority, and in which the output unit communicates the second notification information to user terminals corresponding to the level of informational priority of the second notification information.

Because a notification method control unit changes the terminals to which information is communicated in accordance with the level of priority, the thus implemented processing involves transmitting information of high-level priority to the information terminal currently used by the user and accumulating information of low-level priority on a home terminal, etc., which makes it possible to avoid situations, wherein unnecessary information is communicated to the terminal currently used by the user and disturbs the user's current activities.

The fourteenth invention of this Application provides a computer-executable information notification control method that involves selecting second notification information from first notification information and outputting it. The information notification control method comprises the following steps. It provides an information notification control method comprising the steps of: notification information reception, in which first notification information is received; notification information analysis, in which the type and/or content of the first notification information received in the notification information reception step is analyzed; notification information management, in which temporal variations in the results of the analysis performed in the notification information analysis step are managed along with saving the first notification information received in the notification information reception step in association with the results of the analysis; user situation judgement, in which a user situation is judged in accordance with temporal variations in the results of analysis of the first notification information saved in the notification information management step; notification information selection, in which second notification information is selected from the first notification information stored in the notification information management step in accordance with the user situation; and output, in which the second notification information is outputted. The fourteenth invention of this Application has the same effects as the first invention.

The fifteenth invention of this Application provides an information notification control program selecting second notification information from first notification information and outputting it, the information notification control program causing a computer to function as: notification information reception means for receiving first notification information; notification information analysis means for analyzing the type and/or content of the first notification information received by the notification information reception means; notification information management means for managing temporal variations in the results of the analysis performed by the notification information analysis means along with saving the first notification information received by the notification information reception means in association with the results of the analysis; user situation judgement means for judging a user situation in accordance with temporal variations in the results of analysis of the first notification information saved by the notification information management means; notification information selection means for selecting the second notification information from the first notification information in the notification information management means in accordance with the user situation; and output means for outputting the second notification information.

The sixteenth invention of this Application provides a computer-readable recording medium having recorded thereon an information notification control program executable by an information notification controller and used for selecting second notification information from first notification information and outputting it, wherein the computer-readable recording medium has recorded thereon an information notification control program carrying out the steps of: notification information reception, in which first notification information is received; notification information analysis, in which the type and/or content of the first notification information received in the notification information reception step is analyzed; notification information management, in which temporal variations in the results of the analysis performed in the notification information analysis step are managed along with saving the first notification information received in the notification information reception step in association with the results of the analysis; user situation judgement, in which a user situation is judged in accordance with temporal variations in the results of analysis of the first notification information saved in the notification information management step; notification information selection, in which second notification information is selected from the first notification information stored in the notification information management step in accordance with the user situation; and output, in which the second notification information is outputted.

The scope of the present invention also includes a computer program directing a computer to execute the method described above as well as a computer-readable recording medium that has the program recorded thereon. Here, flexible disks, hard disks, CD-ROMs, MOs, DVDs, DVD-ROMs, DVD-RAMs, BDs (Blue-ray Disks), and semiconductor memory can be cited as examples of the computer readable recording media.

The computer program mentioned above is not limited only to programs recorded on the recording media described above and may be transmitted through networks etc. represented by telecommunication lines, wireless or wired communication lines, and the Internet.

It is an object of the present invention to provide an information notification controller and an information notification control method that resolve such conventional problems and can provide information suited to users.

### BRIEF DESCRIPTION OF THE DRAWINGS

FIG. 1 is a configuration chart of an information notification controller used in Embodiment 1 of the present invention.

FIG. 2 is an exemplary flow chart illustrating the flow of operations in an information notification controller in the present invention.

FIG. 3A is an example of information 301 from the family.

FIG. 3B is an example of work-related information 302.

FIG. 3C is an example of entertainment-related information 303.

FIG. 3D is an example of information from a security system 304.

FIG. 4A is an exemplary source list.

FIG. 4B is an exemplary weighted word list 402.

FIG. 4C is an exemplary ontology 403.

FIG. 5 is an exemplary format used for saving the first notification information and the results of the analysis performed by the notification information analysis unit 102.

FIG. 6 is an exemplary statistical information table.

FIG. 7 illustrates user situations, as defined by the information notification controller 100 in this exemplary embodiment, and a state transition diagram.

FIG. 8 illustrates user situation judgement rules.

FIG. 9A is an exemplary informational priority level list 901 used when the user situation is “Security Oriented”.

FIG. 9B is an exemplary informational priority level list 902 used when the user situation is “Work Oriented”.

FIG. 9C is an exemplary informational priority level list 903 used when the user situation is “Entertainment Oriented”.

FIG. 9D is an exemplary informational priority level list used when the user situation is “Normal”.

FIG. 10 is an exemplary information notification list managed by the situation-dependent information management unit 106.

FIG. 11 is an example of processing generating summary information from a plurality of second notification information records.

FIG. 12 is a network configuration chart comprising user terminals and a server terminal.

FIG. 13 is an explanatory diagram illustrating how the functional units of the information notification controller 100 are distributed between the server terminal and user terminals.

### BEST MODE FOR CARRYING OUT THE INVENTION

Embodiments of the present invention are explained below by referring to drawings.

### Exemplary Embodiment 1

(1) Configuration

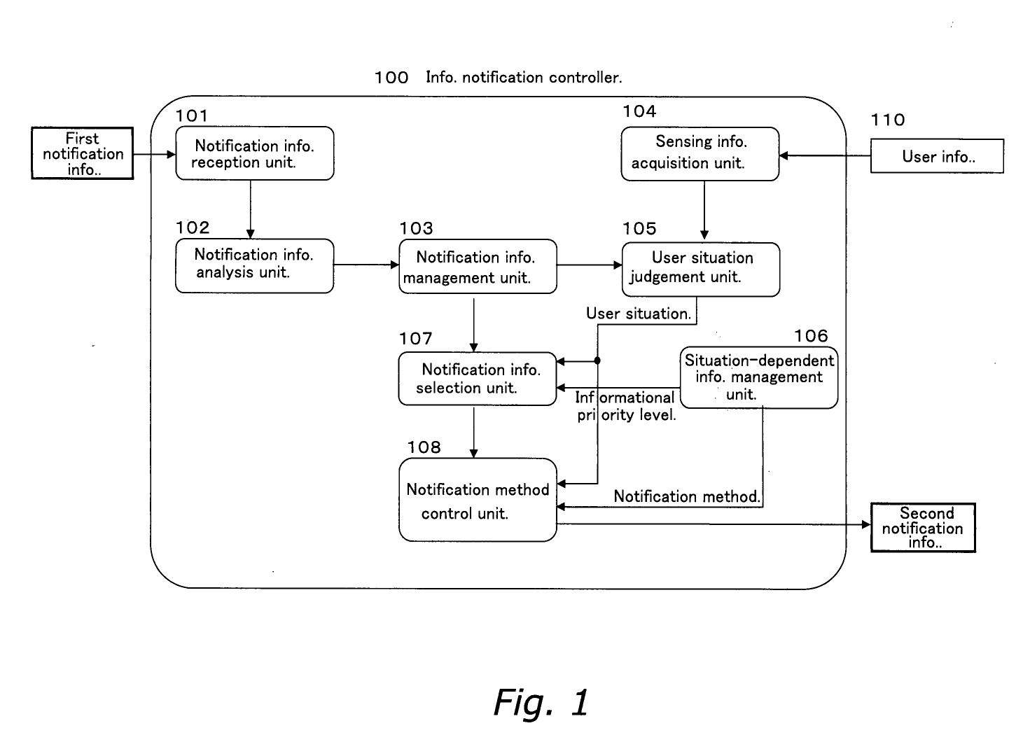

FIG. 1 is a configuration chart of an information notification controller used in Embodiment 1 of the present invention. The information notification controller 100 comprises a notification information reception unit 101, a notification information analysis unit 102, a notification information management unit 103, a sensing information acquisition unit 104, a user situation judgement unit 105, a situation-dependent information management unit 106, a notification information selection unit 107, and a notification method control unit 108. The information notification controller 100 may be formed on a wearable device, e.g. an HMD (Head Mounted Display) or a user terminal belonging the user, such as a mobile phone or a personal computer, or may be installed on a network server. Moreover, the information notification controller 100 may not be set up on a single terminal or server, but may be formed using a plurality of terminals and servers. It should be noted that when the information notification controller 100 is a server terminal, the server terminal outputs second notification information selected by the server terminal to the user terminals. The user terminal receiving the second notification information presents the second notification information to the user by displaying it on the display etc. of its own. On the other hand, when the information notification controller 100 is a user terminal, the user terminals display the second notification information selected by itself on a display, etc.

(Notification Information Reception Unit)

The notification information reception unit 101 receives first notification information provided to user terminals. The received first notification information may be information in any format, for instance, it may be information in text and HTML format, or it may be information in multimedia format, such as audio and video, etc. While the means used to receive the first notification information are not limited to any specific means, but it is possible to use electronic mail protocols such as POP3/IMAP and instant messaging can be used as well. Moreover, methods involving acquisition of the first notification information addressed to users from a network server with the help of HTTP, HTTPS, etc. are acceptable as well.

(Notification Information Analysis Unit)

The notification information analysis unit 102 analyzes the received first notification information. Items subject to analysis in the received first notification information include some or all of the received first notification information and/or related information, for instance, the information categories to which the received first notification information belongs, the importance and urgency of the information, or the frequency of occurrence of terms (including related terms) used in the first notification information, etc. Moreover, more advanced semantic content may be judged with account taken of personal sensibilities and feelings, etc. As a method of analysis of the received first notification information, information categories may be inferred from the sources of the first notification information, and, if the received first notification information is in text format, its content may be inferred from the frequency of occurrence of words contained therein, etc. Moreover, when metadata described in the RDF (Resource Description Framework) format etc. is attached to the first notification information, the metadata can be used to judge the content of the first notification information. The technology of voice recognition and image recognition can be applied to judge the content of the first notification information when the received first notification information is in an audio or video format.

(Notification Information Management Unit)

The notification information management unit 103 saves the first notification information received by the notification information reception unit 101 in association with the results of the analysis performed by the notification information analysis unit 102. The results of the analysis include the results of the analysis of temporal variations in the first notification information. While the method of saving the information is not limited to any specific means, the first notification information and the results of analysis of its content may be stored in a single database or stored in separate databases. Moreover, it is also acceptable to use methods, in which special directories are provided and the results of content judgement of the first notification information are stored separately for each of the first notification information. Moreover, the notification information management unit 103 uses the results of analysis of the content of the first notification information to manage statistical information concerning the received first notification information, such as the frequency of reception etc. for each information category.

(Sensing Information Acquisition Unit)

The sensing information acquisition unit 104 acquires information concerning users, such as information on the users' current location and surrounding shops, etc. As a means of acquiring user information, information on surrounding commodities and shops, buildings, etc. may be acquired using the GPS (Global Positioning System) installed on a terminal carried by a user, such as a mobile phone, as well as based on RFID (Radio Frequency Identification) reader functionality or wireless LAN functionality installed on a portable terminal carried by the user. Otherwise, user information may be acquired from a presence server, i.e. a server that manages current information on the user.

(User Situation Judgement Unit)

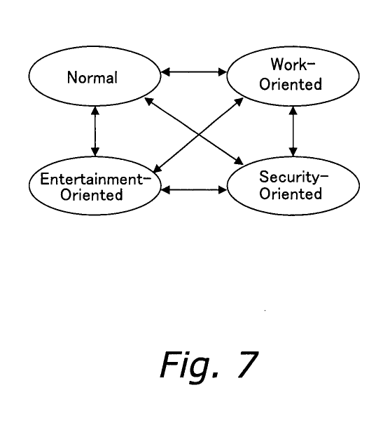

The user situation judgement unit 105 maintains information judgement rules used to make an judgement as to which user situation among those defined in the information notification controller 100 corresponds to the current user situation. Here, the term “user situation” indicates the user situation in the information notification controller 100 and, as shown in FIG. 7, a plurality thereof are defined in the information notification controller 100, such as Normal, Work Oriented, Entertainment Oriented, Security Oriented, etc. The information judgement rules maintained therein are applied to the information held in the notification information management unit 103 and the information acquired by the sensing information acquisition unit 104, with the results used to determine the current user situation.

(Situation-Dependent Information Management Unit)

The situation-dependent information management unit 106 manages information particular to the individual user situations defined in the information notification controller 100. Managed information includes the level of informational priority used when selecting information outputted to the display etc. of its own terminal or information communicated to a user terminal, and a notification method list describing methods used for output to the display etc. of its own terminal or methods used for communicating information to a user terminal. It should be noted that the output method management unit and informational priority management unit of the claims correspond to the situation-dependent information management unit 106.

(Notification Information Selection Unit)

The notification information selection unit 107 acquires the level of informational priority corresponding to the current user situation judged by the user situation judgement unit 105 from the situation-dependent information management unit 107. The notification items to be communicated to the display etc. of a user terminal or its own terminal are selected from the first notification information maintained by the notification information management unit 103 in accordance with the acquired level of informational priority.

(Notification Method Control Unit)

The notification method control unit 108 acquires the notification method corresponding to the current user situation judged by the user situation judgement unit 105 from the notification method list maintained in the situation-dependent information management unit 107. The method used to communicate the second notification information selected by the notification information selection unit 107 from the first notification information is determined in accordance with the acquired notification method lists, followed by notification of information to the display etc. of a user terminal or its own terminal. It should be noted that the notification method control unit 108 may acquire a notification method list from the situation-dependent information management unit 107.

This configuration makes it possible to implement an information notification controller judging the current user situation based on first notification information provided to the user and the surroundings of the user, selecting second notification information corresponding to the situation, and communicating it to the display etc. of a user terminal or its own terminal via notification means corresponding to the situation.

(2) Method of Operation

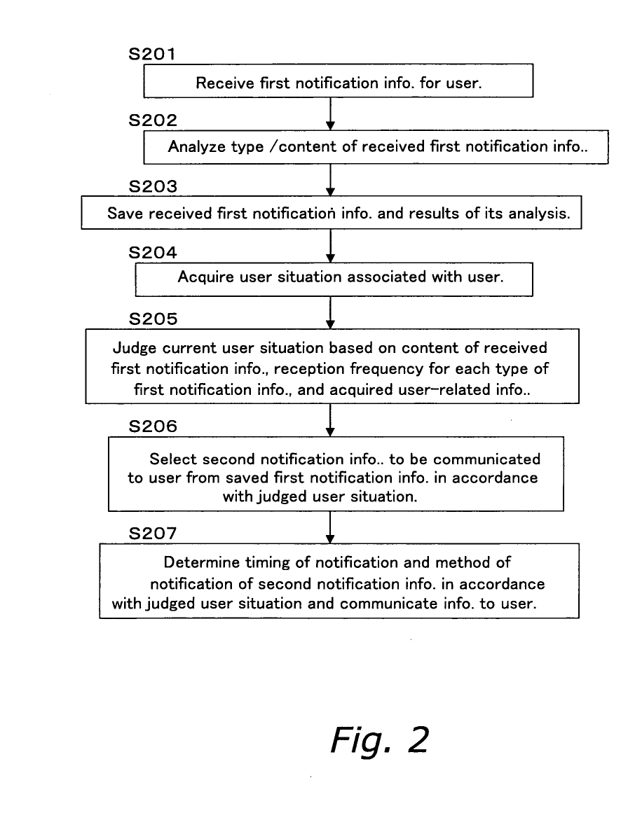

The operation of the information notification controller in the present invention is explained next. The information notification controller in this embodiment implements information notification to the display etc. of a user terminal or its own terminal in accordance with steps S201-S207 illustrated to FIG. 2.

(Step 201)

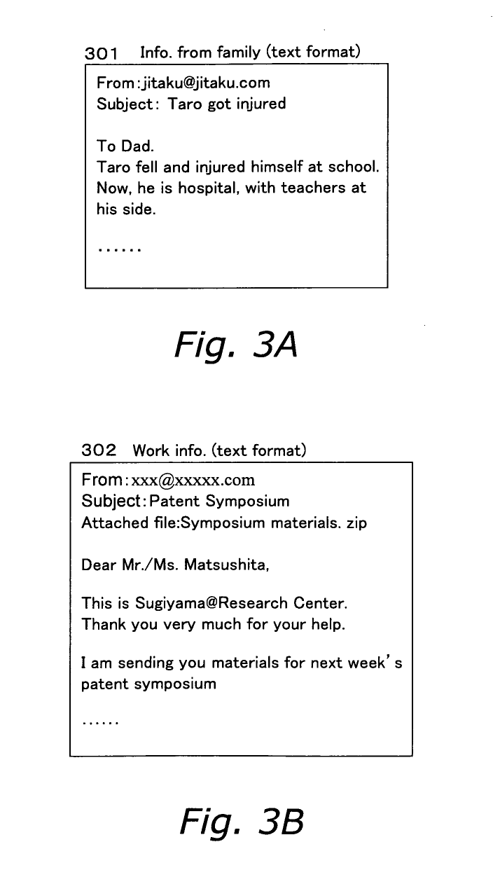

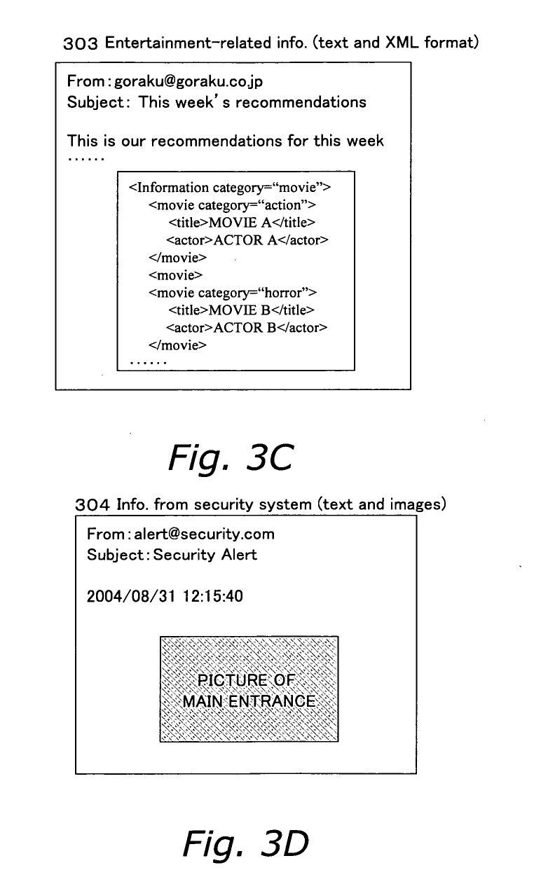

The notification information reception unit 101 receives first notification information sent to users. Examples of the first notification information are illustrated in FIG. 3A-FIG. 3D. FIG. 3A illustrates information from the family 301, which includes e-mail messages etc. transmitted by family members. FIG. 3B illustrates work-related information 302, including work-related e-mail messages etc. sent by people associated with work. FIG. 3C illustrates entertainment-related information 303 including e-mail messages etc. containing entertainment information from an e-mail magazine etc. FIG. 3D illustrates information from a security system 304, which includes e-mail messages etc. containing pictures of a main entrance taken by a home security system. It should be noted that although all of the first notification information is in the form of e-mail messages in this working example, neither the reception format nor the method of reception of the information is limited to e-mail messages and instant messaging can be used as well.

The notification information reception unit 101 transmits the received first notification information to the notification information analysis unit 102.

(Step 202)

The notification information analysis unit 102 analyzes the type and/or content of the first notification information sent from the notification information reception unit 101. The following methods are suggested as examples of the methods used to analyze the first notification information.

(A. Source List-Based Method)

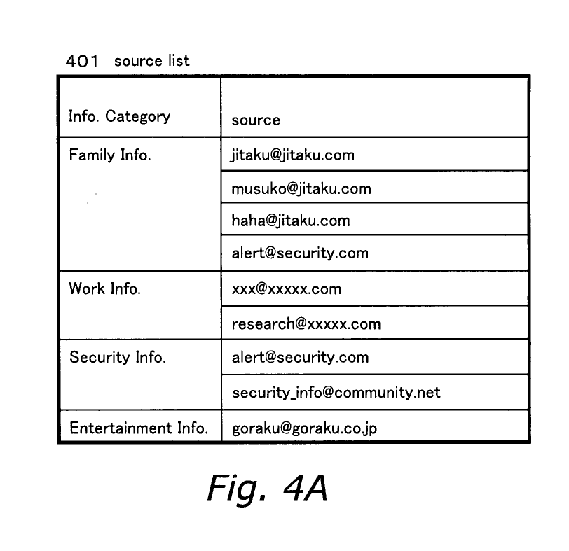

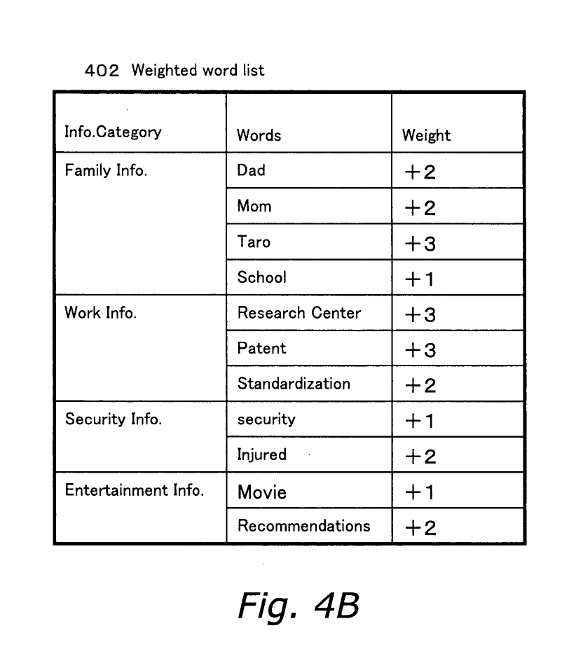

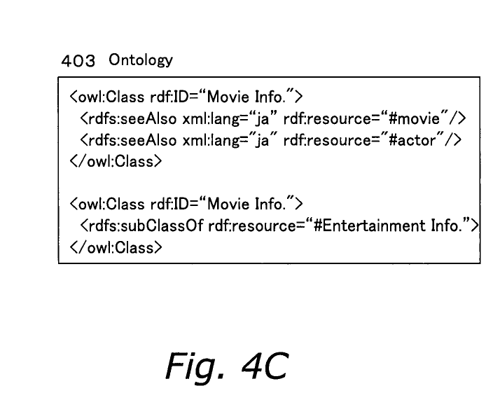

FIG. 4A is a source list that illustrates correspondence between specific information categories and information on sources contained in the first notification information. The source list of FIG. 4A can be used to classify the first notification information into specific information categories. For instance, information from the family 301 (e-mail address: jitaku@jitaku.com) is classified as Family Information, work-related information 302 (e-mail address: xxx@xxxxx.com) is classified as Work Information, entertainment-related information 303 (e-mail address: goraku@goraku.co.jp) is classified as Entertainment Information, and information from a security system 304 (e-mail address: alert@security.com) is classified as information belonging to the information categories of Family Information and Security information.

(B. Weighted Word List-Based Method)

FIG. 4B is a weighted word list 402 used when the information categories of the first notification information are judged based on words contained in the first notification information. The word list is used to assign scores to each information category based on the words contained in the first notification information. For instance, in case of first notification information belonging to the category of information from the family 301, the words “father”, “Taro”, and “school” each appear once in the first notification information. Therefore, based on the word list 402, the information from the family 301 has a weight of 6 in the category of family information. However, since it does not contain work-related words such as “research center” or “patent”, it only has a weight of 0 in the work information category. If the weight of information in a specific information category exceeds a certain threshold after such weighting of the first notification information, the first notification information is determined to belong to this information category.

(C. Metadata-Based Method)

FIG. 4C depicts an ontology 403, which describes semantic relationships between words and is made up of data written in OWL (Web Ontology Language), etc. In the example of the ontology 403, “movie information” is information included in “entertainment information,” with words “movie” and “actor” handled as movie information. The content of the first notification information can be judged by using the metadata contained in this ontology and the first notification information. For instance, the entertainment-related information 303 illustrated in FIG. 3 is a type of first notification information containing metadata describing the semantic content of e-mail messages in XML format. By interpreting the metadata with the help of the ontology 403, the notification information analysis unit 102 makes an judgement that the entertainment-related information 303 is a type of first notification information belonging to entertainment information.

The notification information analysis unit 102 performs an analysis of the type and/or content of the first notification information using either each of the above-mentioned methods A, B or C or all of them and communicates the results of the analysis to the notification information management unit 103.

It should be noted that while in this example the results of the analysis of the first notification information included only information categories, semantic content that is more advanced than the one described above can be judged as well.

(Step 203)

The notification information management unit 103 receives the first notification information and the results of analysis from the notification information analysis unit 102 and saves them in association with one another.

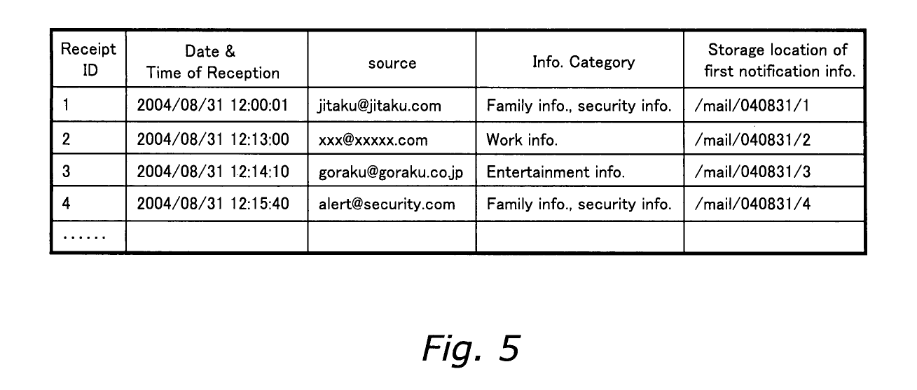

FIG. 5 illustrates an example of the format used for saving the first notification information and the results of the analysis performed by the notification information analysis unit 102. In this example, information is saved in database table format. As shown in FIG. 5, the first notification information is saved in specific directories in the information notification controller 100 and although the table used to save the results of the analysis contains the pathnames for the information, the first notification information may also be saved in the database table directly. Moreover, there is no need to save it in table format and an XML or CSV file, etc. may be used as well.

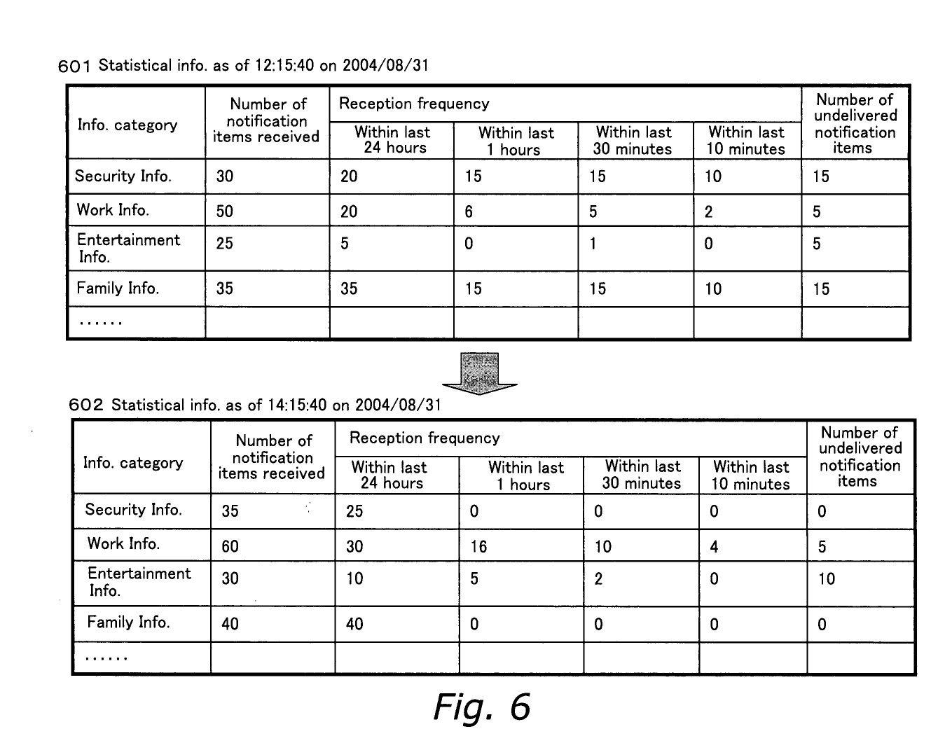

Moreover, as shown in FIG. 6, the notification information management unit 103 uses the results of analysis of the first notification information, as well as the reception date and time, etc., to produce and manage statistical information, such as temporal variations in the frequency of information reception, etc. In the statistical information table of FIG. 6, for each information category of the first notification information, the number of received notification items, the frequency of reception, and the number of undelivered notification items, etc. are described in a single record. FIG. 6 illustrates the time evolution of statistical information from the moment of 12:15:40 on 2004/08/31 to the moment of 14:15:40 on 2004/08/31. It should be noted that the format of the statistical information tables 601 and 602 is merely an example, such that the statistical information is not limited to reception frequency for each information category and the reception intervals used for calculating the frequency are not limited to the intervals shown in FIG. 6.

It should be noted it is acceptable to use a method, in which information such as the information illustrated in FIG. 6 is not maintained on a permanent basis, but is instead successively calculated, if necessary, using the saved information categories, reception dates and times, etc. illustrated in FIG. 5.

(Step 204)

The sensing information acquisition unit 104 acquires information concerning users, such as location information and information concerning people and shops in the vicinity, etc.

(Step 205)

User situations, as defined by the information notification controller 100 in this exemplary embodiment, and a state transition diagram are depicted in FIG. 7. As shown in FIG. 7, suggested user situations include Normal, Entertainment Oriented, Work Oriented, or Security Oriented, with the situations changing in various ways indicated by the arrows.

Based on the information maintained by the notification information management unit 103 and the information acquired by the sensing information acquisition unit 104, the user situation judgement unit 105 makes an judgement as to which of the user situations of FIG. 7 corresponds to the current user situation.

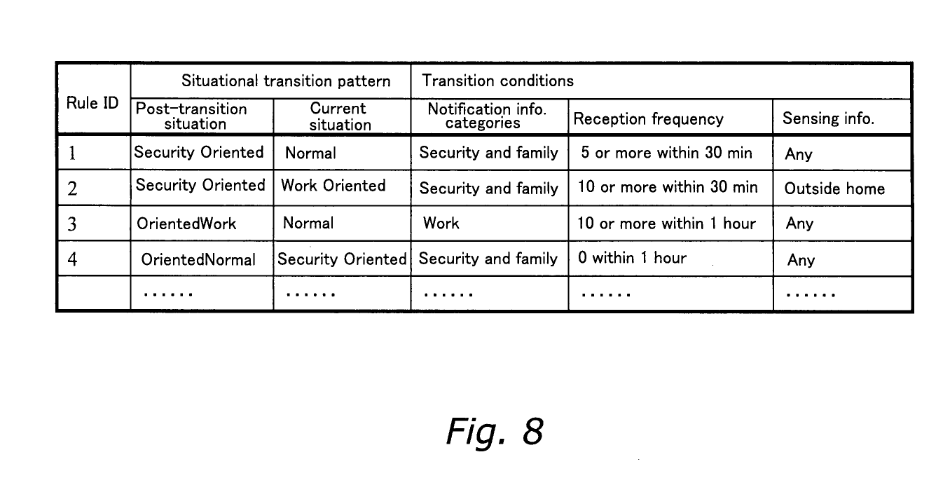

To judge the current user situation, the user situation judgement unit 105 carries out judgement of the user situation in the following manner based on the user situation judgement rules shown in FIG. 8. The user situation judgement rules of FIG. 8 describe which transition conditions apply to which patterns of situational transitions for each pattern of situational transitions between user situations.

Here, the current user situation is assumed to be “Work Oriented,” statistical information concerning the first notification information maintained by the notification information management unit 103 is contained in the statistical information 601, and it is assumed that the user location information acquired by the sensing information reception unit 104 is “Outside of User's Home.” At such time, based on the fact that the current user situation is “Work Oriented,” the judgement rule with a rule ID of “2” is selected as the rule used for the judgement of the user situation. The rule with an ID of “2” deals with a pattern of situational transition from a “Work Oriented” situation to a “Security Oriented” one and describes transition conditions used to make an judgement as to whether a transition to a “Security Oriented” situation is to take place. A determination as to whether such a transition should be carried out is made by determining whether the situation satisfies the description of transition conditions based on information from the notification information management unit 103 and sensing information acquisition unit 104.

Because in this example, as described above, the current location of the user acquired from the sensing information acquisition unit 104 is “Outside of User's Home”, the sensing information-related portion of the transition conditions is fulfilled. Moreover, as is evident from the statistical information 601 illustrated in FIG. 6, the number of messages with information belonging to the categories of “Security Information” and “Family Information” exceeds 15 within the last 30 minutes in both cases. Therefore, it is determined that transition conditions related to the information reception frequency and categories of the first notification information of FIG. 8 are fulfilled. At such time, the user situation judgement unit 105 makes a determination that the current user situation has transitioned from being “Work Oriented” to being “Security Oriented” and communicates this information to the notification information selection unit 107 and notification method control unit 108.

Also, after that, as shown in FIG. 6, when the statistical information 601 concerning the first notification information maintained by the notification information management unit 103 changes into the statistical information 602, the user situation judgement unit 105 selects the judgement rule with a rule ID of “4” in FIG. 8 corresponding to a “Security Oriented” situation, i.e. the current user situation. An judgement is then made as to whether the changed statistical information 602 and information maintained by the sensing information acquisition unit 104 meet the transition conditions. In the transition condition with a rule ID of “4”, the sensing information is arbitrary. Therefore, transition conditions concerning the sensing information are satisfied regardless of the information maintained by the sensing information acquisition unit 104. Because the statistical information 602 contains a record to the effect that no information belonging to the Family Information or Security Information has been delivered within the last hour, transition conditions concerning the frequency of information reception and notification information categories are fulfilled. For this reason, the user situation judgement unit 105 makes an judgement that the current user situation has transitioned from being “Security Oriented” to being “Normal” and communicates this information to the notification information selection unit 107 and notification method control unit 108.

In this manner, the user situation judgement unit 105 judges the current situation of the user based on the type and/or content of the information provided to the user terminal as well as its reception frequency. As a result, when there is an increase in the number of notifications such as information from the family 301 in the form of e-mail messages etc. from family members or information from a home security system 302, the user situation is changed to “Security Oriented”. On the other hand, when the delivery of e-mail messages containing information from the family 301 and information from the home security system 302 etc. stops, it becomes possible to perform user situation judgement processing based on the first notification information received by the user terminal, on which the user situation has been changed to “Normal”.

It should be noted that the timing with which the user situation is judged, may be either synchronized with the reception of the first notification information or be based on regular time intervals. Moreover, the format of the judgement rules illustrated in FIG. 8 is merely an example and the use of other formats, as well as complex judgement rules based on soft computing technologies such as neural networks, etc., is also possible.

(Step 206)

The notification information selection unit 107 selects second notification information outputted to the display etc. of a user terminal or its own terminal from the first notification information saved by the notification information management unit 103 based on the user situation judged by the user situation judgement unit 105 in step S205. When the notification information selection unit 107 receives a notification of changes in the user situation from the user situation judgement unit 105, an informational priority level list corresponding to the user situation to be obtained after the changes is acquired as reference values for selecting notification information from the situation-dependent information management unit 106.

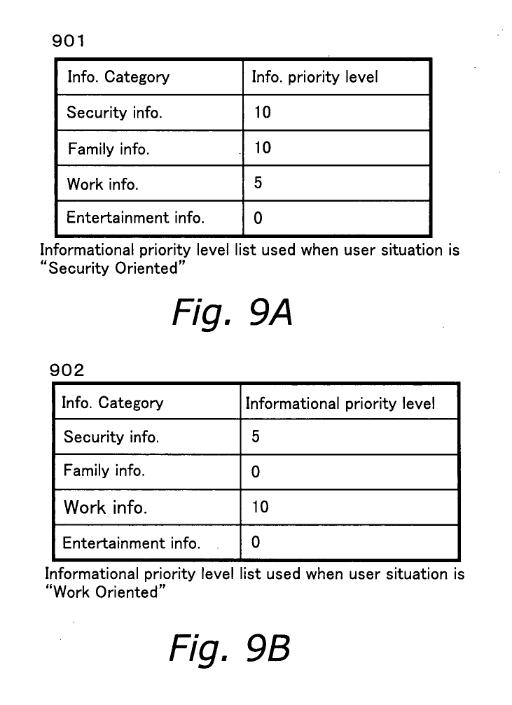

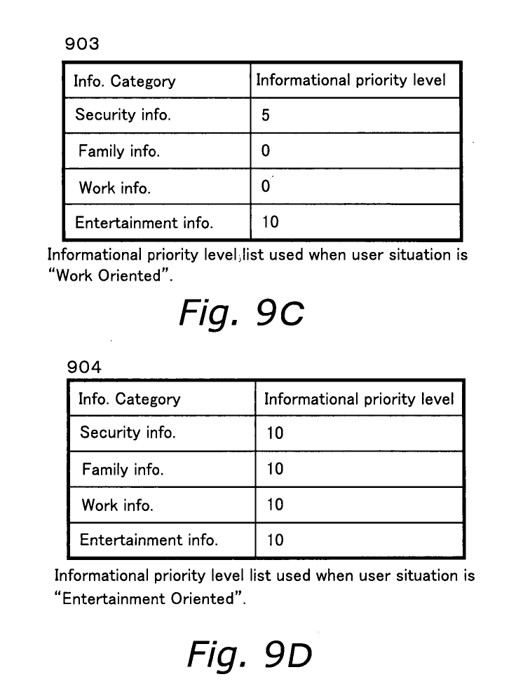

FIGS. 9A through 9D show examples of informational priority level lists corresponding to the respective user situations maintained by the situation-dependent information management unit 106. FIG. 9A is an informational priority level list 901 used when the user situation is “Security Oriented”, FIG. 9B is an informational priority level list 902 used when the user situation is “Work Oriented”, FIG. 9C is an informational priority level list 903 used when the user situation is “Entertainment Oriented”, and FIG. 9D is an informational priority level list used when the user situation is “Normal”. The level of informational priority is a reference value used to determine which pieces of information in the first notification information saved by the notification information management unit 103 should be given priority and communicated to the user, and, the higher the priority level is, the easier it becomes to immediately communicate it upon receipt. The level of informational priority for each information category is set and maintained using the informational priority level lists illustrated in FIG. 9.

In an example shown here, the notification information selection unit 107 selects second notification information to be communicated to the user from the information saved in the notification information management unit 103. In this example, it is assumed that the current user situation is “Security Oriented”, and the first notification information illustrated in FIG. 5 is managed in the notification information management unit 103. At such time, the notification information selection unit 107 acquires the situation priority level list 901 used when the user situation is “Security Oriented” from the situation-dependent management unit 106. The priority level of “Safety Information” and “Family Information” is the highest in the situation priority level list 901. Therefore, the notification information selection unit 107 selects the first notification information with a receipt ID of “1” and a receipt ID of “4”, i.e. the “Safety Information” and “Family Information,” as the second notification information from the managed information illustrated in FIG. 5. The notification information selection unit 107 then transmits the priority level according to the situation priority level list 901 and the selected second notification information to the notification method control unit 108. Subsequently, when there is no first notification information classified as Safety Information or Family Information in the notification information management unit 103, first notification information associated with “Work Information,” whose priority level follows that of “Safety information” and “Family information” on the situation priority level list 901, is selected as second notification information. In this example, the priority level and second notification information with a receipt ID of “2” from FIG. 5 are communicated to the notification method control unit 108.

It should be noted that the timing with which the second notification information is selected from the first notification information in the notification information selection unit 107 may be synchronized with the timing of reception of the first notification information by the notification information reception unit 101 or may be based on regular time intervals. Otherwise, the selection of the second notification information may be carried out based on the timing of receipt of requests of the notification method control unit.

(Step 207)

The notification method control unit 108 determines the method used for communicating the second notification information selected by the notification information selection unit 107 in step 206 to the display etc. of a user terminal or its own terminal based on the user situation judged by the user situation judgement unit 105 in step 205.

In order to determine the method of communicating the second notification information corresponding to the user situation, an information notification method corresponding to the user situation to be obtained after the changes is acquired from the an information notification method list in the situation-dependent information management unit 106 when the notification information control unit 108 receives information on changes in the user situation from the user situation judgement unit 105.

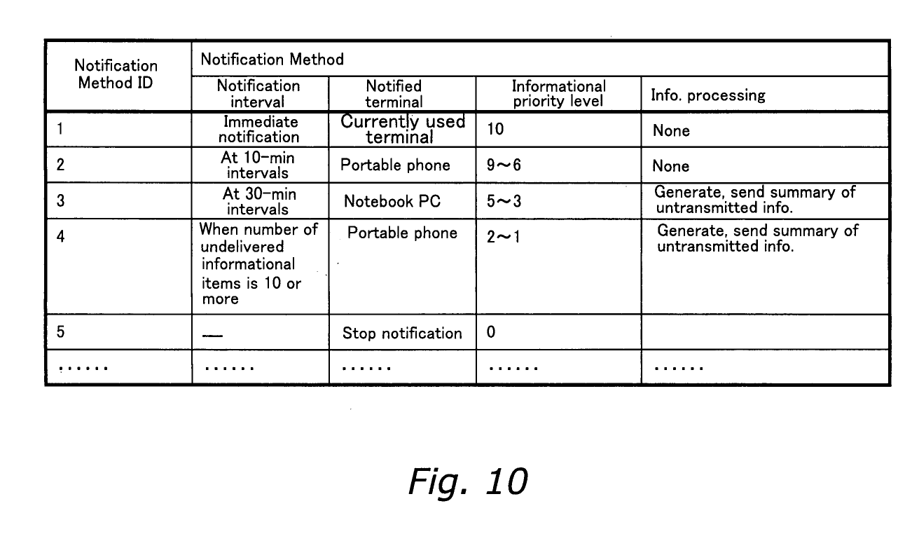

An exemplary information notification list managed by the situation-dependent information management unit 106 is illustrated in FIG. 10. The information notification method list is a list for maintaining the methods used when information is communicated to the display etc. of a user terminal or its own terminal, and, in the present embodiment, it contains a record of the notification intervals used to communicate the second notification information, the communicated terminals, to which the second notification information is communicated, and the processing means used for the notification information for each level of informational priority. It should be noted that the level of informational priority used here is a value provided by the above-mentioned informational priority level list.

In the example shown here, the notification method control unit 108 communicates information selected by the notification information selection unit 107 to the display etc. of a user terminal or its own terminal. It is assumed that the current user situation is “Security Oriented” and that the informational priority level list 901 illustrated in FIG. 9 and the information notification method list illustrated in FIG. 10 are used in this example. As can be appreciated from the informational priority level list 901 of FIG. 9, the level of informational priority of the “Safety information” and “Family information” is “10.” Here, when the notification information selection unit 107 transmits second notification information of FIG. 5 belonging to “Family information” and “Safety information” with a receipt ID of “2” and a receipt ID of “4”, respectively, to the notification method control unit 108 using a priority level of “10”, the notification method control unit 108 selects the method of information notification corresponding to the priority level of the received second notification information from the information notification method list. Because the method of information notification corresponding to the second notification information with a priority level of “10” in the information notification method list of FIG. 10 is the notification method with an ID of “1”, the notification method control unit 108 communicates the second notification information to the display etc. of a user terminal or its own terminal in accordance with the notification method described under ID No. “1”. In this case, the second notification information is immediately transmitted to the terminal currently used by the user (a mobile phone, notebook PC, etc.).

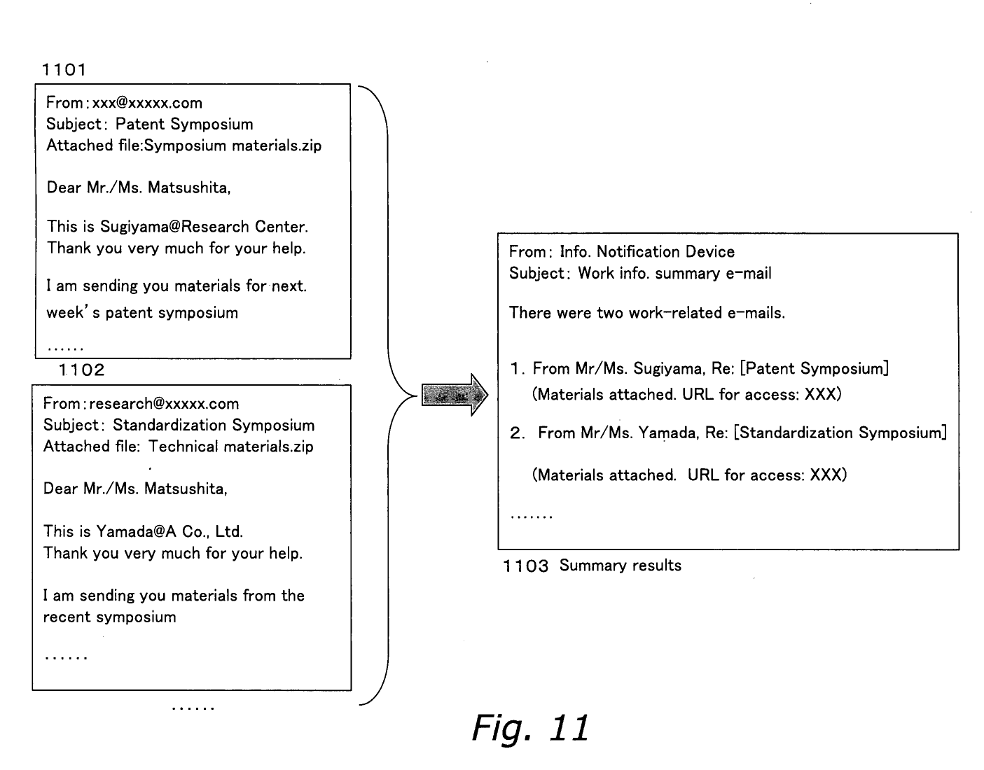

In addition, when the notification information selection unit 107 transmits second notification information of FIG. 5 belonging to “Work Information” with a receipt ID of “2” to the notification method control unit 108 using a priority level of “5”, the notification method control unit 108 selects the method of information notification corresponding to the priority level of “5” from the information notification method list. Because the information notification method corresponding to information with a priority level of “5” is the notification method with an ID of “3”, the notification method control unit 108 communicates the second notification information to the display etc. of a user terminal or its own terminal in accordance with the notification method described under ID No. “3”. In such a case, the second notification information with a receipt ID of “2” is transmitted upon lapse of 30 minutes from the time of transmission of information belonging to priority levels “3”-“5”. Moreover, if the second notification information with a priority level of “3”-“5” is conveyed from the notification information selection unit 107 separately while information with a receipt ID of “2” is awaiting transmission, a summary of untransmitted information is generated in accordance with the description of the notification method with an ID “3”. As shown in FIG. 11, this processing generates summary information from a plurality of second notification information records. In FIG. 11, untransmitted information 1101 and 1102 is maintained by the notification method control unit 108 without transmitting it to the display etc. of a user terminal or its own terminal due to reasons such as restrictions on notification intervals etc. Untransmitted information 1103 consists of summary information generated from the untransmitted information 1101 and 1102. While there are no particular limitations concerning the method of summary generation, one may consider a method, wherein a summary is generated based on lists of notification information sources, subjects, etc., such as in FIG. 11. The generated summary is transmitted as second notification information upon lapse of 30 minutes from the transmission of the previous information with a priority level of “3”-“5”. Aggregating the second notification information of low-level priority as illustrated in this example makes it possible to reduce the amount and frequency of information communicated to the display etc. of a user terminal or its own terminal.

In addition, when information with a priority level of “0” is transmitted from the notification information selection unit 107, the notification method control unit 108, based on the description of the notification method with an ID of “5”, does not transmit anything to the display etc. of a user terminal or its own terminal so long as the user situation is “Security Oriented”.

It should be noted that, as far as the order of execution of Step 204 is concerned, the step is either substituted for steps 201-203 or is carried out in parallel.

(Effects)

The information notification controller 100 selects second notification information from delivered first notification information based on the level of informational priority of the first notification information determined in accordance with temporal variations in the user situation. In addition, outputting the selected second notification information to the display etc. of a user terminal or its own terminal makes it possible to provide the user with constantly changing information in accordance with the user situation. Therefore, for instance, even in case of information with which the user has not been concerned, changes in the user situation with which the user becomes concerned can be detected by analyzing, and managing temporal variations in, the first notification information provided to the user based on e.g. the type, content, and frequency of the information. In addition, information suited to users can be provided to the user by selecting information corresponding to the changed situation of the user and providing it to the user. As a result, it is possible to prevent notification of entertainment information to users waiting for regional disaster information and thus avoid hurting the users' feelings. In addition, because the notification information control unit 108 outputs the second notification information to the display etc. of a user terminal or its own terminal using methods corresponding to the user situation, the provision of the second notification information to the user can be carried out in an appropriate manner.

### Other Exemplary Embodiments

(1) In the exemplary embodiment above, the information notification controller 100 may be a server terminal outputting second notification information to user terminals or it may be a user terminal. Moreover, a portion of the functional units contained in the information notification controller 100 can be included in the server terminal, with the remaining portion be included in the user terminals.

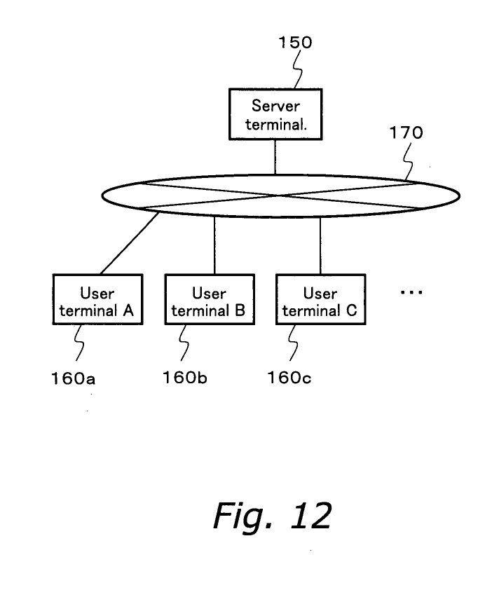

FIG. 12 is a network configuration chart comprising user terminals and a server terminal. The server terminal 150 and user terminals 160 (160a,160b,160c, . . . ) are connected through a network 170. If the information notification controller 100 is a server terminal 150, the server terminal 150 comprises a notification information reception unit 101, a notification information analysis unit 102, a notification information management unit 103, a sensing information acquisition unit 104, a user situation judgement unit 105, a situation-dependent information management unit 106, a notification information selection unit 107, and a notification method control unit 108. The analysis and management of the received first notification information is carried out by the notification information management unit 103, notification information analysis unit 102, and notification information reception unit 101 of the server terminal 150. The acquisition and judgement of user situations is performed by the user situation judgement unit 105 and sensing information acquisition unit 104 of the server terminal 150. Moreover, the situation-dependent information management unit 106 of the server terminal 150 manages a notification method list describing levels of informational priority and notification methods, etc. The notification information selection unit 107 of the server terminal 150 selects second notification information from the first notification information managed by the notification information management unit 103 in accordance with the level of informational priority corresponding to the user situation. The notification method control unit 108 of the server terminal 150 then outputs the second notification information to the user terminals 160 in accordance with a notification method corresponding to the current user situation. As a result, the user terminal 160 presents the second notification information acquired from server terminal 150 to the user by displaying it on the display etc. of its own terminal. In such a case, the delivered first notification information is not received in its entirety because the user terminals 160 receive and display only the second notification information selected by the server terminal 150. At such time, the user terminals 160 do not require time to select the second notification information from the first notification information.

Moreover, if the information notification controller 100 is a user terminal 160, the user terminal 160 comprises a notification information reception unit 101, a notification information analysis unit 102, a notification information management unit 103, a sensing information acquisition unit 104, a user situation judgement unit 105, a situation-dependent information management unit 106, a notification information selection unit 107, and a notification method control unit 108. The analysis and management of the received first notification information is carried out by the notification information management unit 103, notification information analysis unit 102, and notification information reception unit 101 of the user terminal 160. The acquisition and judgement of user situations is performed by the user situation judgement unit 105 and sensing information acquisition unit 104 of the server terminal 160. Moreover, the situation-dependent information management unit 106 of the user terminal 160 manages a notification method list describing levels of informational priority and notification methods, etc. The notification information selection unit 107 of the user terminal 160 selects information from the first notification information managed by the notification information management unit 103 in accordance with the level of informational priority corresponding to the user situation. The notification method control unit 108 of the user terminal 160 then outputs the second notification information in accordance with a notification method corresponding to the current user situation. At such time, the user terminal 160 itself selects second notification information from the first notification information and outputs and displays the second notification information on the display etc. of the device itself.

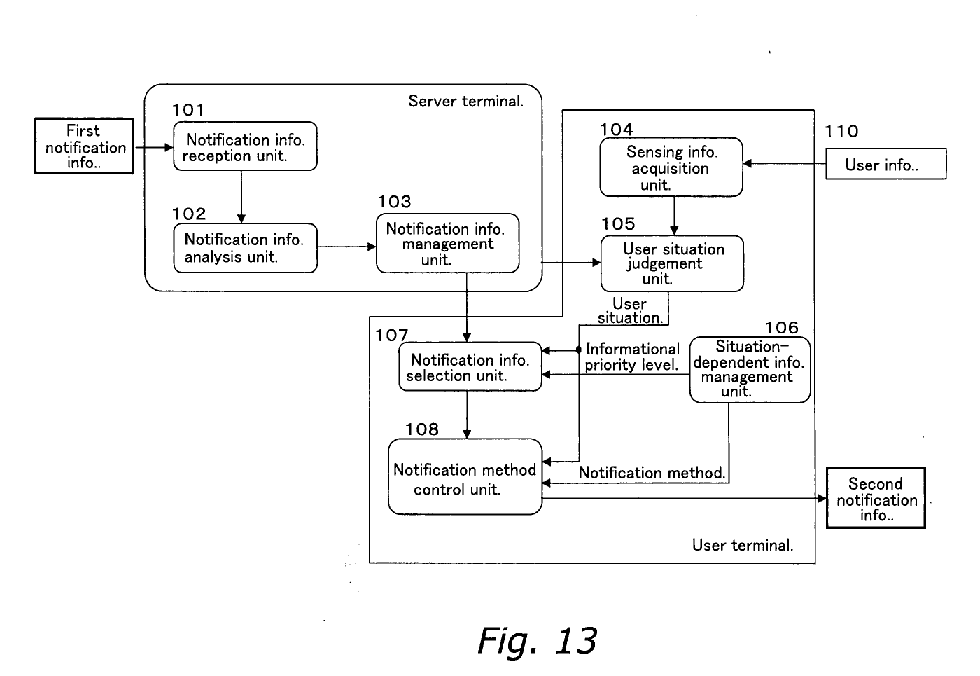

FIG. 13 is an explanatory diagram illustrating how the functional units of the information notification controller 100 are distributed between the server terminal and user terminals. The server terminal 150 comprises a notification information reception unit 101, a notification information analysis unit 102, a notification information management unit 103, and the user terminals 160 comprise a sensing information acquisition unit 104, a user situation judgement unit 105, a situation-dependent information management unit 106, a notification information selection unit 107, and a notification method control unit 108. The analysis and management of the received first notification information is carried out by the notification information management unit 103, notification information analysis unit 102, and notification information reception unit 101 of the server terminal 150. The acquisition and judgement of user situations is performed by the user situation judgement unit 105 and sensing information acquisition unit 104 of the user terminal 160. Moreover, the situation-dependent information management unit 106 of the user terminal 160 manages a notification method list describing levels of informational priority and notification methods, etc. The notification information selection unit 107 of the user terminal 160 selects information from the first notification information managed by the notification information management unit 103 of the server terminal 150 in accordance with the level of informational priority corresponding to the user situation. The notification method control unit 108 of the user terminal 160 then outputs the second notification information in accordance with a notification method corresponding to the current user situation. At such time, the user terminal 160 itself selects second notification information from the first notification information and outputs and displays the second notification information on the display etc. of the device itself.

(2) The scope of the present invention also includes a computer program directing a computer to execute the method described above as well as a computer-readable recording medium that has the program recorded thereon. Here, flexible disks, hard disks, CD-ROMs, MOs, DVDs, DVD-ROMs, DVD-RAMs, BDs (Blue-ray Disks), and semiconductor memory can be cited as examples of the computer readable recording media.

The computer program mentioned above is not limited only to programs recorded on the recording media described above and may be transmitted through networks etc. represented by telecommunication lines, wireless or wired communication lines, and the Internet.

(3) The functionality of the information notification controller described in the embodiments may be implemented in the form of an LSI, i.e. an integrated circuit. Although here it is called LSI, depending on the degree of integration, it may be an IC, a system LSI, a super LSI, or an ultra LSI.

In addition, the integrated circuit-based method is not limited to LSIs and may include dedicated circuits or general-purpose processors. After fabricating LSIs, it is possible to use programmable FPGA (Field Programmable Gate Arrays) or reconfigurable processors, which allow for reconfiguration of settings and connections between circuit cells in LSIs.

### INDUSTRIAL APPLICABILITY

The information notification controller according to the present invention possesses functionality used for determination of the user situation based on information received by the user, and is useful as a system for controlling information notification to users.

1. An information notification controller selecting second notification information from first notification information and outputting it, the information notification controller comprising:
a notification information reception unit receiving the first notification information;
a notification information analysis unit analyzing the type and/or content of the first notification information received by the notification information reception unit;
a notification information management unit managing temporal variations in the results of the analysis performed by the notification information analysis unit along with saving the first notification information received by the notification information reception unit in association with the results of the analysis;
a user situation judgement unit judging a user situation in accordance with temporal variations in the results of analysis of the first notification information saved by the notification information management unit;
a notification information selection unit selecting second notification information from the first notification information in the notification information management unit in accordance with the user situation; and
an output unit outputting the second notification information.

2. The information notification controller according to claim 1, further comprising an informational priority level management unit managing the level of informational priority of the first notification information in association with the user situation,
wherein the notification information selection unit selects the second notification information from the first notification information in the notification information management unit according to the level of informational priority corresponding to the user situation judged by the user situation judgement unit.

3. The information notification controller according to claim 1, further comprising an output method management unit managing an output method of the second notification information depending on the user situation,
wherein the output unit outputs the second notification information in accordance with an output method corresponding to the user situation judged by the user situation judgement unit.

4. The information notification controller according to claim 1, wherein the notification information analysis unit maintains a source list used to classify information into categories based on the sources of the information and analyzes the type and/or content of received first notification information by applying the source list to source-related information contained in the first notification information received by the notification information reception unit.

5. The information notification controller according to claim 1, wherein the notification information analysis unit maintains a weighted word list showing associations between specific words and information categories and analyzes the type and/or content of the first notification information by applying the weighted word list to words contained in the first notification information received by the notification information reception unit.

6. The information notification controller according to claim 1, wherein the notification information analysis unit maintains an ontology describing semantic relationships within information and analyzes the type and/or content of the first notification information by performing ontology-based semantic interpretation of metadata contained in the first notification information received by the notification information reception unit.

7. The information notification controller according to claim 1, wherein the notification information analysis unit analyzes the type and/or content of information by performing image recognition on image information contained in the first notification information received by the notification information reception unit.

8. The information notification controller according to claim 1, comprising a sensing information acquisition unit acquiring user information,
wherein the user situation judgement unit judges a user situation in accordance with temporal variations in user information acquired from the sensing information acquisition unit in addition to temporal variations in the results of analysis of the first notification information saved by the notification information management unit.

9. The information notification controller according to claim 1, wherein at least one of the type, content, and reception frequency of the first notification information is contained in the first notification information saved by the notification information management unit and
the user situation judgement unit judges a user situation based on the at least one of the type, content, and reception frequency of the first notification information.

10. The information notification controller according to claim 2, wherein the output unit aggregates and outputs untransmitted information.

11. The information notification controller according to claim 10, wherein the output unit aggregates and outputs information of low-level informational priority.

12. The information notification controller according to claim 2, further comprising an output timing management unit managing the output timing of the second notification information in association with the level of informational priority,
wherein the output unit outputs the second notification information in accordance with an output timing corresponding to the level of informational priority of the second notification information.

13. The information notification controller according to claim 2, further comprising an output terminal management unit managing a user terminal outputting the second notification information in association with the level of informational priority,
wherein the output unit communicates the second notification information to user terminals corresponding to the level of informational priority of the second notification information.

14. A computer-executable information notification control method for selecting second notification information from first notification information and outputting it, the information notification control method comprising the steps of:
notification information reception, in which first notification information is received;
notification information analysis, in which the type and/or content of the first notification information received in the notification information reception step is analyzed;
notification information management, in which temporal variations in the results of the analysis performed in the notification information analysis step are managed along with saving the first notification information received in the notification information reception step in association with the results of the analysis;
user situation judgement, in which a user situation is judged in accordance with temporal variations in the results of analysis of the first notification information saved in the notification information management step;
notification information selection, in which second notification information is selected from the first notification information stored in the notification information management step in accordance with the user situation; and
output, in which the second notification information is outputted.

15. An information notification control program selecting second notification information from first notification information and outputting it, the information notification control program causing a computer to function as:
notification information reception means for receiving the first notification information;
notification information analysis means for analyzing the type and/or content of the first notification information received by the notification information reception means;
notification information management means for managing temporal variations in the results of the analysis performed by the notification information analysis means along with saving the first notification information received by the notification information reception means in association with the results of the analysis;
user situation judgement means for judging a user situation in accordance with temporal variations in the results of analysis of the first notification information saved by the notification information management means;
notification information selection means for selecting the second notification information from the first notification information in the notification information management means in accordance with the user situation; and
output means for outputting the second notification information.

16. A computer-readable recording medium having recorded thereon an information notification control program executable by an information notification controller and used for selecting second notification information from first notification information and outputting it, the computer-readable recording medium storing information notification control program carrying out the steps of:
notification information reception, in which the first notification information is received;
notification information analysis, in which the type and/or content of the first notification information received in the notification information reception step is analyzed;
notification information management, in which temporal variations in the results of the analysis performed in the notification information analysis step are managed along with saving the first notification information received in the notification information reception step in association with the results of the analysis;
user situation judgement, in which a user situation is judged in accordance with temporal variations in the results of analysis of the first notification information saved in the notification information management step;
notification information selection, in which second notification information is selected from the first notification information stored in the notification information management step in accordance with the user situation; and
output, in which the second notification information is outputted.
